(19) United States
(12) Patent Application Publication
(10) Pub. No.: US 2010/0077843 A1
(43) Pub. Date: Apr. 1, 2010

(54) SUBSTANCE IDENTIFICATION APPARATUS AND METHODS OF USING

(76) Inventors: Loganathan DORAISAMY, San Diego, CA (US); Serge BOBROFF, San Diego, CA (US); Michael Craig BURRELL, Clifton Park, NY (US); Walter N. FREEMAN, San Diego, CA (US); Sankaran KUMAR, San Marcos, CA (US); Frank John MONDELLO, Niskayuna, NY (US); Joseph Dominic NAPOLI, Wilmington, MA (US); Tracy Lynn PAXON, Waterford, NY (US); William Scott SUTHERLAND, Murrieta, CA (US)

Correspondence Address: Patent Docket Department;Armstrong Teasdale LLP, One Metropolitan Square, Suite 2600, St. Louis, MO, 63102-2740, US

(21) Appl. No.: 12/411,198

(22) Filed: Mar. 25, 2009

Related U.S. Application Data
(60) Provisional application No. 61/041,168, filed on Mar. 31, 2008.

(51) Int. Cl. G01N 1/10; B01L 3/02

(52) U.S. Cl. 73/64.56; 73/864.01

(57) ABSTRACT

A substance identification system comprises interrelated components. A fluidics cartridge is configured to permit suspension of a sample of a substance of interest in a liquid medium, and to permit transfer of the suspended sample into a container via syringe/needle action or other suitable actuation means. The container is configured to be fixedly or removably coupled with the fluidics cartridge. An interface cartridge is configured to position the container for analysis by a portable substance identification device.

### CROSS-REFERENCE TO RELATED APPLICATIONS

This application claims the benefit under 35 U.S.C. §120 of the earlier filing date of co-pending U.S. Provisional Application Ser. No. 61/041,168, filed on Mar. 31, 2008, the entire contents of which are hereby incorporated by reference.

### BACKGROUND

1. Field of the Invention

The field of the invention generally relates to devices configured to detect chemical and biological threats, and more particularly to certain new and useful advances in portable substance identification devices of which the following is a specification, reference being had to the drawings accompanying and forming a part of the same.

2. Discussion of Related Art

A substance identification device is an apparatus configured to assay a sample using Raman Spectroscopy and/or other measurement techniques, to determine whether the sample contains one or more substances. Examples of substances include, but are not limited to, organic chemicals, inorganic chemicals, and bioagents. Examples of bioagents include bacteria, viruses, pathogens and toxins.

First responders (police, firefighters, emergency medical personnel) and military personnel sometimes face unknown biological threats. To combat such threats, portable substance identification devices have been developed for use in the field.

Presently, most portable substance identification devices involve significant user-initiated activity to perform an assay. In fact, much of the required user-initiated activity mimics most of the steps that would be performed in a traditional laboratory assay. Such user-initiated activity is not well suited for use by first responders who often have limited mobility and dexterity (due to protective gear), limited visibility (due to face shields and eye protection), and limited time (often less than 15 minutes) to perform a field-assay at an incident site (an area thought to be contaminated with one or more substances of interest). Currently, many portable substance identification devices take fifteen minutes or longer to perform an assay.

### SUMMARY

A substance identification apparatus configured to enable in-situ assays of substances of interest, including organic chemicals, inorganic chemicals, bioagents, etc., is provided. The assays may be performed in the field or in a laboratory setting. Methods of using the apparatus to perform an assay are also provided.

In an embodiment, a substance identification apparatus includes one or more of three interrelated parts. A first member is configured to permit suspension of a sample in a liquid medium and to permit transfer of the suspended sample into a second member (via syringe/needle action or other suitable actuation means). The liquid medium may be buffered. The second member is configured to house one or more reagents in solid or liquid form, appropriately sealed and/or shielded to preserve a shelf life of the one or more reagents. The second member is also configured either to removably or fixedly couple with the first member and/or with a third member. The third member is configured to removably couple with a portable substance identification device. The third member is configured to enable formation of a pellet of magnetic particles within the second member, and to enable incidence of a laser beam on the formed pellet to generate a Surface Enhanced Raman Spectroscopy (SERS) signal to be detected and processed by the portable substance identification device. This signal can be processed by a computer processor to identify one or more substances of interest (if any) that were collected in the sample. A non-limiting example of a portable substance identification device is the STREETLAB MOBILE™ portable substance identification system manufactured by GE Security, Inc., of Bradenton, Fla.

For ease of reference only, and not by way of limitation, the first member may be referred to as a “fluidics cartridge.” For ease of reference only, and not by way of limitation, the second member may be referred to herein as one of a “container,” a “vial,” a “reaction chamber,” and the like. For ease of reference only, and not by way of limitation, the third member may be referred to herein as an “interface cartridge.”

Embodiments of the claimed invention are aimed at advantageously providing a more rapid method for performing a biological assay than the methods provided by prior portable detection systems.

Moreover, embodiments of the claimed invention are aimed at advantageously enabling multiple tests to be performed from a single test sample. This is a significant advantage when only a limited sample is available, and considering that sampling and dilution often constitute a significant fraction of a total assay time. Embodiments of the claimed invention allow the operator to run multiple assay tests with a single sampling step, greatly improving efficiency and potentially reducing the per-test cost of an assay.

Additionally, embodiments of the claimed invention simplify the sample collection, dilution, and assay steps by performing them in an integrated substance identification apparatus. Where applicable, one or more components of the integrated substance identification apparatus are appropriately sized so as to be easily used when the operator is wearing protective gear. This allows the operator to perform all testing without having to collect a sample and transfer it to a laboratory from the scene of a hazardous materials response incident.

Additionally, embodiments of the claimed invention provide for controlled sample collection, dilution, and deposition of aliquots from a diluted sample in a repeatable manner to improve assay precision with minimal user steps.

Embodiments of the claimed invention advantageously and uniquely combine multiple sample manipulation steps that previously were conducted separately, using individual devices (collectors, pipettes, buffer containers, liquid transfer devices, etc.). By integrating these steps into a single apparatus, performance of bioassays is simplified and more tightly controlled, which advantageously minimizes sources of user error.

Other features and advantages of the claimed invention will become apparent by reference to the following description taken in connection with the accompanying drawings.

### BRIEF DESCRIPTION OF THE DRAWINGS

Reference is now made briefly to the accompanying drawings, in which:

FIGS. 1, 2, and 3 are transparent side views of a first embodiment of a fluidics cartridge and container;

FIG. 4 is a side-view of a prototype having the attributes of the first embodiment of a fluidics cartridge and container;

FIGS. 5 and 6 are transparent side views of a second embodiment of a fluidics cartridge and container;

FIGS. 7 and 9 are side views of a first exemplary fluidics cartridge 101 constructed in accordance with the principles of the first embodiment shown in FIGS. 1, 2, and 3;

FIG. 8 is a cross-sectional view of the first exemplary fluidics cartridge 101;

FIGS. 10, 11, 12, 13, 14, and 15 are transparent side views of a second exemplary fluidics cartridge having a container carrier and constructed in accordance with the principles of the first embodiment shown in FIGS. 1, 2, and 3;

FIG. 16 is a transparent side view of an embodiment of an interface cartridge that is removably coupled with a portable substance identification device and to which a container is illustratively attached;

FIGS. 17 and 18 are transparent side views of an embodiment of an interface cartridge coupled with a portable substance identification device and further coupled with a fluidics cartridge and a container;

FIG. 19 is a transparent side view of an embodiment of an interface cartridge coupled with a portable substance identification device and further coupled with a fluidics cartridge and a container, the fluidics cartridge including a validation tab and a validation capsule;

FIGS. 20-22 are side views of an embodiment of a container and container holder, as well as a method for making the same;

FIG. 23 is an end view of a container holder showing an assay opening and a container retaining member formed therein;

FIG. 24 is a side view of a fully assembled container holder that illustrates a ridge configured to retain the container holder assembly within one of a fluidics cartridge and an interface cartridge; and

FIGS. 25-30 are side perspective views of the first exemplary fluidics cartridge of FIGS. 7, 8, and 9, modified in accordance with the principles of the first embodiment of the fluidics cartridge shown in FIGS. 1, 2, and 3, but with an ergonomic skin, a port cover, a receptor port cover, and a container holder that includes an RFID tag.

Like reference characters designate identical or corresponding components and units throughout the several views, which are not to scale unless otherwise indicated.

### DETAILED DESCRIPTION

Specific configurations and arrangements of the claimed invention, discussed below with reference to the accompanying drawings, are for illustrative purposes only. Other configurations and arrangements that are within the purview of a skilled artisan can be made, used, or sold without departing from the spirit and scope of the appended claims. For example, while some embodiments of the invention are herein described with reference to portable substance identification devices that are configured to detect one or more types of biological and/or chemical substances of interest, a skilled artisan will recognize that embodiments of the invention can be implemented for use with any suitable type of substance identification device.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

### First Embodiment

### PUSH & PULL

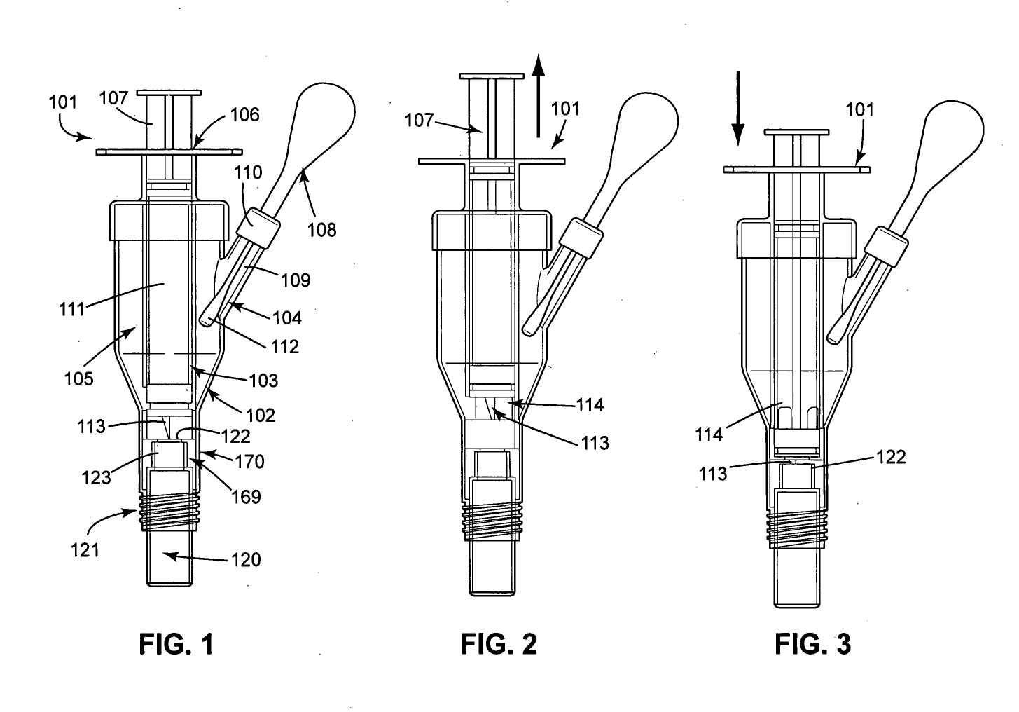

FIGS. 1, 2, and 3 are transparent side views of a first embodiment of a fluidics cartridge 101 configured to receive a container 120.

In this first embodiment, the fluidics cartridge 101 includes an outer chamber 102 and an inner chamber 103. FIGS. 1, 2, and 3 illustratively depict the outer chamber 102 and the inner chamber 103 as each having a cylindrical shape, but other shaped chambers can also be used—e.g. rectangular. A port 104 which may be oriented differently than shown in FIGS. 1, 2, and 3 is connected to the outer chamber 102. The port 104 includes a hollow bore 109 in communication with an interior of the outer chamber 102. The port 104 is thus configured to receive a sample collector 108. Non-limiting examples of a sample collector include a swab, a brush, cloth, etc. The outer chamber 102 stores a liquid medium 105), which may be a phosphate buffered saline solution. One or more access openings may be formed in a portion of the structure that defines the inner chamber 103. For example, the one or more access openings may be formed in a wall of the inner chamber 103. The inner chamber 103 may be a syringe 106 with one or more access openings placed for the phosphate buffered saline solution to enter from the outer chamber 102. The syringe 106 comprises a plunger 107 configured to sealably engage and move within an interior of the inner chamber 103. In an embodiment, an end 170 of the fluidics cartridge 101 comprises a receptor 169. The receptor 169 connects to a portion of the outer chamber 102 and encloses a conduit 113. In one embodiment, the conduit 113 occupies a fixed position. In another embodiment, the conduit 113 is movable from a first retracted position to a second extended position. As shown in the Figures, the receptor 169 is configured and dimensioned to prevent the second portion of the conduit 113 from contacting or sticking an object external to the fluidics cartridge, such as, but not limited to an operator of the assay system. In an embodiment the receptor 169 comprises a connector 121, which is configured to couple a container 120 with the receptor 169. Depending on the embodiment, the connector 121 may be configured to removably or fixedly couple the container 120 with the fluidics cartridge 101, or a portion thereof, such as the receptor 169. FIGS. 1, 2, and 3 each illustratively depict the connector 121 as a thread, but any suitable type of connector 121 can be used. For example, connector 121 may alternatively be a slip-on connection or other form of quick-connect.

In use, the wet or dry tip 112 of the sample collector 108 is used to collect a substance of interest, which may contain one or more organic chemicals, inorganic chemicals, and/or bioagents. Then after removing a temporary seal (not shown in FIGS. 1, 2, and 3) at an entry port, the sample collector 108 is inserted with the sample into the fluidics cartridge 101. The entry port is closed with a cap 110 as shown in FIG. 1. The cap 110 may be attached to, or integrally formed as part of, the stem of the sample collector 108. The cartridge is then shaken to dissolve/suspend the sample in the liquid medium 105.

The container 120 is then coupled with the receptor 169 of the fluidics cartridge 101. Alternatively, the fluidics cartridge 101 is attached to the container 120 before the sample collector 108 is inserted within the fluidics cartridge 101. Either way, in an embodiment, an end of the container 120 is configured to mate with a connector 121. A non-limiting example of a connector 121 is a threaded connector, but other types of connectors can be used. In such an embodiment where the conduit 113 occupies a fixed position, the container 120 is configured to be rotated about its vertical axis until a portion of the conduit 113 pierces the self-healing sealable member 122 of the container 120. In an embodiment where the conduit 113 is movable, the container 120 is rotated about its vertical axis until the self-healing sealable member 122 of the container 120 is positioned a predetermined distance from the conduit 113. Thereafter, the conduit 113 is moved from the first retracted position to the second extended position to pierce the self-healing member 122 of the container 120.

The plunger 107 is pulled to create a negative pressure in the inner chamber 103 that causes the liquid medium 105 to flow from the outer chamber 102 into the inner chamber 103 via the one or more access openings.

The plunger 107 is then pushed so that a conduit 113 punctures a self-healing sealable member 122 of the container 120 (which may be resealably sealed with the self-healing sealable member, such as, but not limited to: foil or a rubber septum) or/and the seal at the bottom of the inner chamber 103. The conduit 113 is a hollow, pointed object such as, but not limited to, a syringe needle or a vented syringe needle. After the self-healing sealable member 122 of the container 120 has been pierced, the plunger 107 is pushed to inject the liquid medium 105 through the conduit 113 and into the container 120. In one embodiment, the container 120 contains one or more reagents and/or magnetic particles. The conduit 113 is then withdrawn from the container 120.

As will be later described, in one embodiment, the container 120 may thereafter be fitted to an interface cartridge for formation of a pellet of SERS-tagged particles and/or magnetizable particles and laser-based Raman spectroscopic analysis of the pellet. In other embodiments, the contents of the container 120 can be analyzed using other kinds of techniques, such as, fluorescence, colorimetric, etc. It is understood, that pellet formation is beneficial, depending on the analysis to be performed, but is not always required. For example, a separation and re-suspension technique can be used.

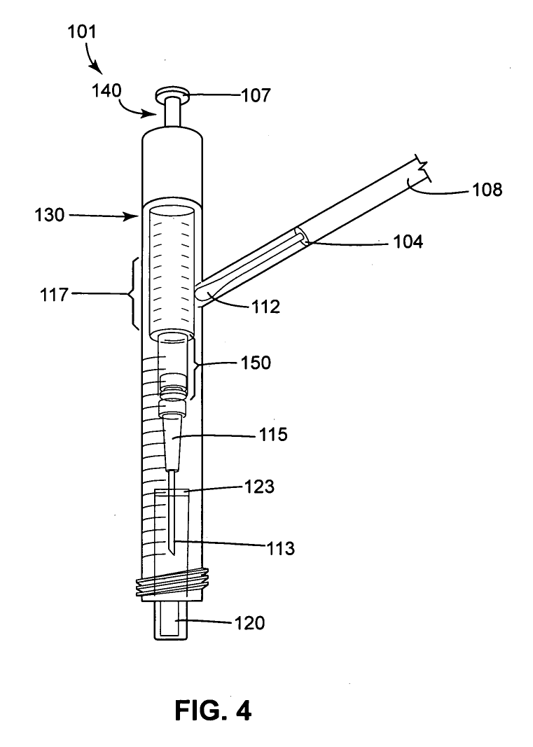

FIG. 4 is a side-view of another example of the first embodiment of a fluidics cartridge 101, configurable to receive a container 120, which is shown in FIGS. 1, 2, and 3. The fluidics cartridge 101 includes an outer sheath 130 in which a dispensing mechanism 140 (e.g., “dispenser”) is disposed. By way of example, and not limitation, the exemplary prototype apparatus illustrated in FIG. 4 was constructed using a 15 mL centrifuge conduit as the outer sheath 130, the interior of which functions as an outer reservoir, configured to store a liquid medium 105. A portion of a wall of the syringe body 115 has one or more openings 117 (e.g., openings) formed therein that are configured to permit entry of the liquid medium 150 into an interior (e.g., bore) of the syringe when the plunger 107 is pulled. A hollow sampling port 104 is connected to a sidewall of the outer sheath, and is configured to receive at least a collector tip 112 and stem of a sample collector 108. When the sample collector 108 is inserted within the sampling port 104, at least the tip 112 of the sample collector 108 is positioned within the interior (bore) of the outer sheath.

One end of the outer sheath 130 is configured to function as a needle guard and to receive an autosampler container 120. One end of the autosampler container 120 (the end insertable within the interior bore of the outer sheath) has a cap 123. A self-healing sealable member 122 may be attached to the cap 123. By way of example, and not limitation, the self-healing sealable member 122 may be a foil, a septum, a snap-cap, and/or any other type of re-sealable, leak-proof member.

Also by way of example, and not limitation, the dispensing mechanism 140 was constructed of a 1 mL syringe 106, which includes a syringe body 115 and a plunger 107 slidably disposed within an interior bore of the syringe body 115. An injection needle (e.g., conduit 113) was fixed to one end of the 1 mL syringe 106 with the needle's fluid path connected to the syringe body 115's interior bore. In this exemplary prototype apparatus, the needle (e.g., conduit 113) serves as a piercing device, but is not actuated by the syringe plunger 107. Rather, it pierces the top of the container 120 when the entire dispensing mechanism (e.g., syringe body 115, plunger 107, and needle (e.g., conduit 113)) is positioned over the container 120, and pushed. Once the needle (e.g., conduit 113) has pierced the container 120 to create a fluid pathway, the syringe plunger 107 is activated to (a) draw a sample aliquot 150 (of a predetermined amount of liquid medium 105 mixed with the collected sample from the interior of the outer sheath) through one or more openings formed in the syringe body 115, and to (b) dispense fluid through the injection needle into the autosampler container 120. Thereafter, the autosampler container 120 may be removed from the outer sheath 130. By way of example, and not limitation, an exemplary sample aliquot 150 is about 300 μL of liquid medium 105.

### Second Embodiment

### PUSH

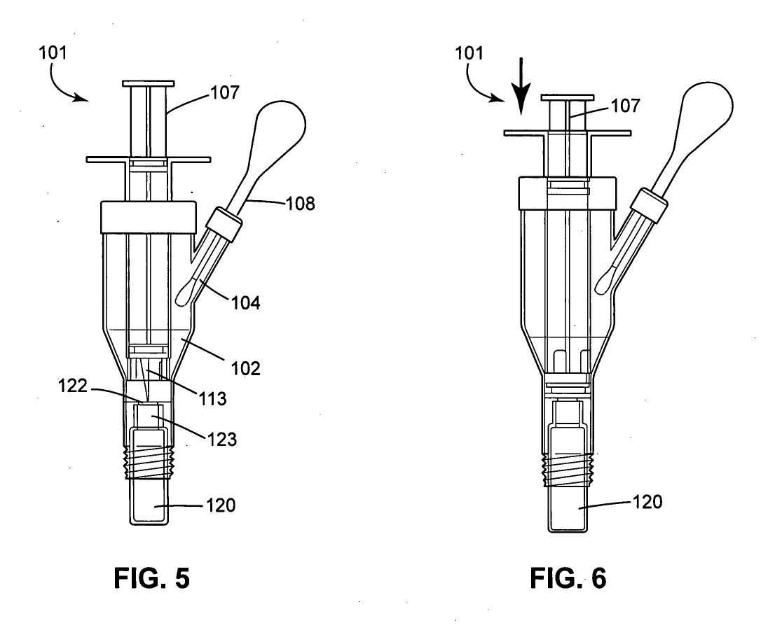

FIGS. 5 and 6 are cut-away side views of a second embodiment of a fluidics cartridge 101 configurable to receive a container 120. This second embodiment is similar to the first embodiment described above with reference to FIGS. 1, 2, and 3, with the following difference. As shown in FIG. 5, the plunger 107 is already retracted, with part of the liquid medium 105 (e.g., phosphate buffered saline solution) pre-stored in the interior of the outer chamber 102. Therefore, no “PULL” action is required. Instead, once the sample collector 108 is inserted into the port 104, as shown in FIGS. 5 and 6, and the liquid medium 105 is mixed with the sample—by shaking or other means, the plunger 107 is pushed to puncture a self-healing sealable member 122 seal (or septum), which may be attached to the cap 123, and inject the sample-laden liquid medium 105 into the container 120 (e.g., reaction chamber).

In passing, it is noted that the prototype apparatus of FIG. 4 may be adapted to implement this second “PUSH” embodiment.

### Automatic Fluidics Cartridge

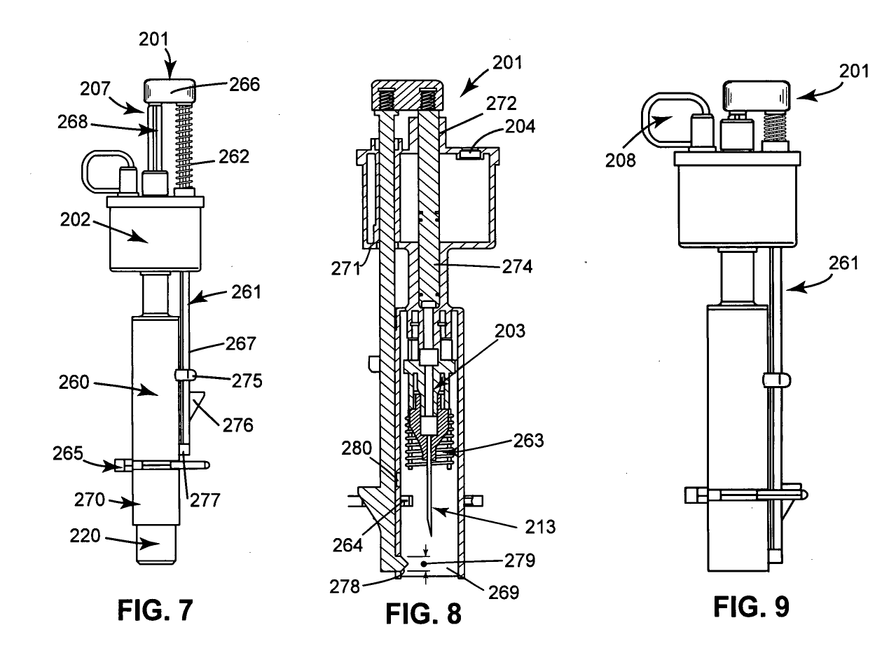

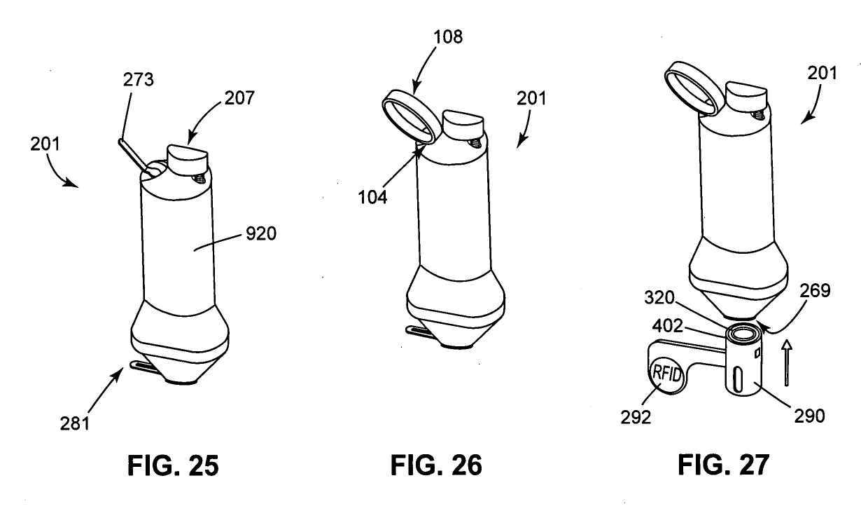

FIGS. 7 and 9 are side views of a first exemplary automatic fluidics cartridge 101 constructed in accordance with the principles of the first “PULL & PUSH” embodiment shown in FIGS. 1, 2, and 3. FIG. 8 is a cross-sectional view of the first exemplary fluidics cartridge 101. It should be noted that the first exemplary automatic fluidics cartridge 201 of FIGS. 7, 8, and 9 can be modified to implement the second “PUSH” embodiment shown in FIGS. 5 and 6. It should also be noted that the views of FIGS. 7, 8, and 9 illustrate components of a fluidics cartridge 101, most of which are enclosed within an ergonomic skin or body. For clarity of illustration, this ergonomic skin, or body, is intentionally omitted from FIGS. 7, 8, and 9, but is shown as 920 in FIG. 25.

Referring to FIGS. 7, 8, and 9 together, components of the first exemplary automatic fluidics cartridge 201 include a plunger 207, an outer chamber 202, a sleeve 260, a plunger lock 261, spring 262, spring 263, a container lock retaining member 264, a conduit 213, and a container lock 265. The plunger 207 includes a plunger handle 266 and a plunger rod 267. The bore 268 of the plunger 207 slidably extends through the outer chamber 202 and terminates in the conduit 213. In one embodiment, the sleeve 260 is integrally formed with the outer chamber 202. Alternatively, the sleeve 260 is connected to the outer chamber 202. In either case, the sleeve 260 is configured to prevent the conduit from contacting an object external to the fluidics cartridge, which may be, but is not limited to, an operator of the fluidics cartridge. The sleeve 260 may also house the spring 263. One end 270 of the sleeve 260 comprises a receptor 269, which is configured to receive a container 120.

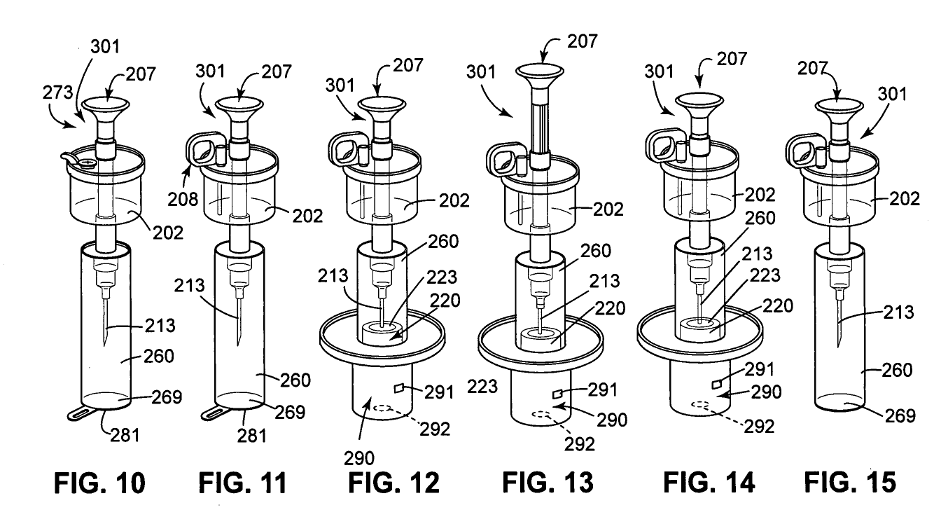

The outer chamber 202 includes a port 204, a plunger rod channel 271, and a plunger stem channel 272. The port 104 is configured to receive a sample collector 208. Prior to use, the port 104 may be sealed with a port cover (See FIG. 10). The port cover 273 may be foil or other type of removable seal. Alternatively, prior to use, the sample collector 208 may be stored inserted within the port 204. An interior of the outer chamber 202 is configured to store a predetermined (large) amount of a liquid medium (105 in FIGS. 1, 2, and 3). In one embodiment, the outer chamber 202 may store about 3 mL of the liquid medium 105. When a sample collector 208 containing a sample is inserted within the port 204, the collected sample mixes dissolves or suspends in the liquid medium 105. When the plunger 207 is pushed, all, or a predetermined sample aliquot, of the sample-laden liquid medium 105 is injected through a flow path of the conduit 213 and into a container 220 inserted within the receptor 269.

The plunger lock 261 includes a plunger rod 267. Like the plunger stem 274, one end of the plunger rod 267 is attached to the plunger handle 266. The remainder of the plunger rod 267 is parallel the plunger stem 274. A portion of the plunger rod 267 passes through a channel 271 formed in the outer chamber 102. As further explained below, a locking pawl 278 is formed at a free end 277 of the plunger rod 267. A portion of the plunger rod 267 passes through a plunger rod guide 275 formed on an exterior of the sleeve 260. A container lock release member 276 is formed in a portion of the plunger rod 267 proximate the locking pawl 278. The container lock release member 276 is configured to move the container lock 265 relative to the sleeve 260 when the plunger 107 is pushed.

A free end 277 of the plunger rod 267 includes a locking pawl 278 that engages, at different times, either a first detent 279 or a second detent 280. The first detent 279 is an opening formed through a sidewall of the sleeve, proximate the sleeve's open end. The second detent 280 is an opening formed through the same sidewall of the sleeve, but between the first detent 279 (or container 120 lock) and the outer chamber 102. In one embodiment, the second detent 280 is positioned proximate the container 120 lock, on a side of the container 120 lock that is furthest from the first detent 279. Each of the first detent 279 and the second detent 280 are configured to permit a conical portion of the locking pawl 278 to protrude past an interior sidewall of the receptor 269. The conical portion of the locking pawl 278 is configured to engage a top portion of a container 220 (or a container holder) that is inserted within the receptor.

When the automatic fluidics cartridge 201 of FIGS. 7, 8, and 9 is configured for the PULL-PUSH embodiment of FIGS. 1, 2, and 3, and no container 220 is inserted within the receptor, the locking pawl 278 engages the first detent 279 to lock the plunger 207 in a first (down) position, with the spring 262 compressed and urging against the plunger handle 266. When the automatic fluidics cartridge 201 of FIGS. 7, 8, and 9 is configured for the PUSH embodiment of FIGS. 5 and 6, and no container 220 is inserted within the receptor 269, the locking pawl 278 engages the second detent 280 to lock the plunger 207 in a second (up) position.

The container lock 265 is disposed on an exterior of the sleeve 260, proximate an end 270 of the sleeve in which the receptor 269 is formed, and is spring biased. A portion of the container lock 265, referred to as a container lock-retaining member 264, is urged by the container 120 lock biasing means (not shown) to extend through a corresponding opening in the sleeve 260 and to protrude into the receptor 269.

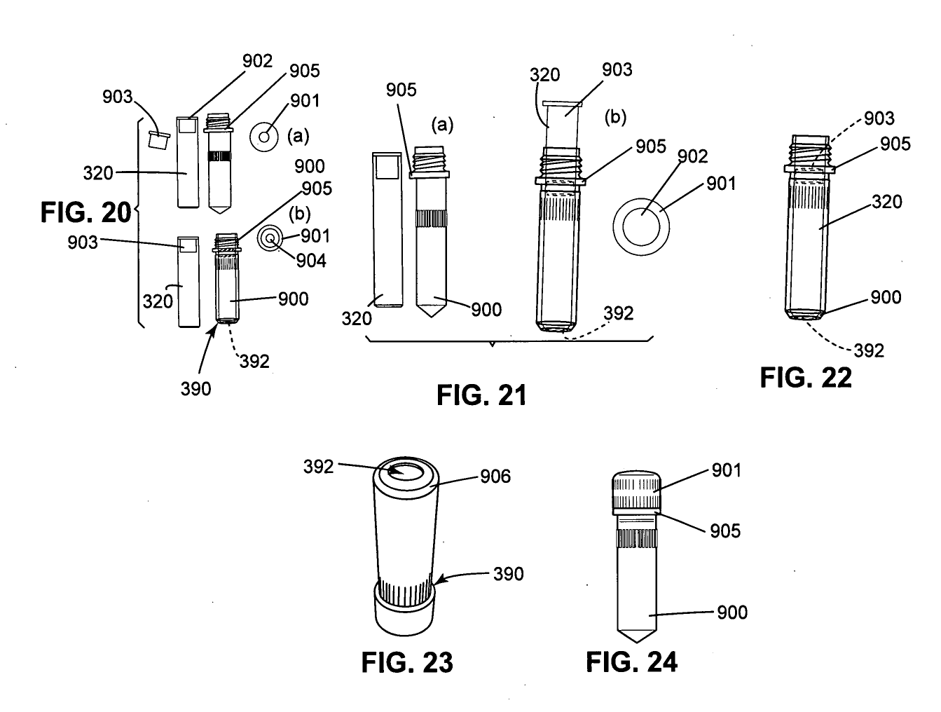

For illustration and not limitation, in the following description of an exemplary mode of operation, the automatic fluidics cartridge 201 of FIGS. 7, 8, and 9, is assumed to be configured for the “PULL & PUSH” embodiment of FIGS. 1, 2, and 3, with the plunger 207 locked in the first (down) position; and is further assumed to be used combination with a container 220, or a container lock 265. The container 220 may comprise a retaining member 905 on an exterior portion thereof. See, for example, FIGS. 20(a), 20(b), 21(a), 21(b), 22, and 24) (e.g., a lip, a ring, a threaded portion, etc.). Referring briefly to FIG. 23, the container holder 290 may comprise another container retaining member 906 positioned proximate an assay opening 392. For convenience, the container-retaining member 905 may be referred to as a “first container-retaining member,” and the container-retaining member 906 may be referred to as a “second container-retaining member.”

In use, a container 220, or a container holder (290 in FIG. 12) containing the container 220, is inserted into the receptor 269. As the container 120, or the container holder 290, is inserted, a capped end of the container 220 (and/or a portion of the container holder 290) contacts the conical end of the locking pawl 278, which protrudes from the first detent 279 into the interior of the receptor 269. As the container 220, or container holder 290, continues to be inserted, it urges the locking pawl 278 out of the first detent 279, contrary a biasing force provided by the plunger rod 267. Urged by the plunger 107 biasing means, the plunger 107 then moves away from the sleeve's free end 270 until the locking pawl 278 enters the second detent 280.

As the container 220, or container holder 290, is further inserted within the receptor 269, it urges the spring-loaded container lock 265 and the container lock retaining member 264 away from the receptor 269, such that the container lock retaining member 264 is retracted into its corresponding opening in the sidewall of the sleeve 260. Once the container retaining member (not shown) (e.g., lip, ring, thread, etc.) of the container 220 (or the container holder 290) is past (or adjacent to) the container lock retaining member 264, the spring-loaded container lock 265 and the container lock retaining member 264 are urged by the container lock biasing means (not shown) back to their original positions and into contact with the container retaining member (not shown) to prevent removal of the container 220. Thereafter, the capped end of container 220 (or a portion of the container holder 290) again contacts the conical end of the locking pawl 278 (which is in the second detent 280) and compresses the spring 263.

At this point, the conical end of the locking pawl 278 is urged out of the second detent 280, against the biasing force of the plunger rod 274 such that the plunger lock rod 267 is again free to move. Thereafter, the plunger 207 is pushed to compress the plunger biasing means 262, to inject a predetermined amount of the sample-laden liquid medium 105 into the container 220, and to move the container lock release member 276, an angled flange affixed to a surface of the plunger rod 267, into a corresponding opening (not shown) formed in the spring-loaded container lock 265 and into contact with a portion of a wall that forms the corresponding opening. As the plunger 207 is pushed, the plunger lock rod 267 moves the container lock release member 276 further through the corresponding opening in the spring-loaded container lock 265 to urge the spring-loaded container lock 265 and the container lock retaining member are away from the receptor 269. This frees the container 220 (or container holder 290) to move within the receptor 269. When the plunger 207 is fully depressed, the conical end of the locking pawl 278 again occupies the first detent 279 and abuts a sidewall of the container 220 (or a sidewall of the container holder 290) to lock the plunger 207 in the first (down) position. The spring 263 then operates to partially (but not fully) eject the container 220, or the container holder 290, from the receptor 269. The first detent 279 and the second detent 280 may be formed in the same wall of the sleeve 260 and/or in-line with each other.

Thereafter, the container 220, or container holder 290, is manually removed from the receptor 269, and locking pawl 278 is urged fully into the first detent 279, and into the receptor 269, by a biasing force of the plunger rod 267. Thereafter, another container 220, or container holder 290, can be inserted in the receptor 269, and the above process repeated until less than about 300 μL of sample-laden liquid medium 105 remains in the outer chamber 202.

The operation of an embodiment of the fluidics cartridge 201 of FIGS. 7, 8, and 9, modified to be configured for the PUSH embodiment of FIGS. 5 and 6, would be the same as just described, except that the plunger 207 would be locked in the second (up) position (shown in FIG. 7), in which the locking pawl 278 is fully inserted within the second detent 280.

### Manual Fluidics Cartridge

FIGS. 10, 11, 12, 13, 14, and 15 are side views of a second exemplary fluidics cartridge 301 constructed in accordance with the principles of the first “PULL & PUSH” embodiment shown in FIGS. 1, 2, and 3. It should also be noted that the views of FIGS. 10, 11, 12, 13, 14, and 15 illustrate components of a fluidics cartridge 301, most of which are enclosed within an ergonomic skin or body. For clarity of illustration, this ergonomic skin, or body, is intentionally omitted from FIGS. 7, 8, and 9, but is shown as 920 in FIG. 25. It should be noted that the second exemplary fluidics cartridge 301 of FIGS. 10, 11, 12, 13, 14, and 15 can be modified to implement the second “PUSH” embodiment shown in FIGS. 5 and 6. Referring to FIGS. 10, 11, 12, 13, 14, and 15, this second exemplary fluidics cartridge 301 comprises a plunger 207, an outer chamber 202, a sleeve 260, a receptor 269 formed in an end of the sleeve 269, and a conduit disposed within the sleeve 160 and coupled with the plunger 207 and/or the outer chamber 202; and is similarly constructed as the first exemplary automatic fluidics cartridge 201 with the following differences:

First, this second exemplary fluidics cartridge 301 of FIGS. 10, 11, 12, 13, 14, and 15 lacks the plunger biasing means, the plunger lock, the plunger rod, the locking pawl, the first detent, the second detent, the plunger rod guide, the container release member, and the spring that were shown in the first exemplary automatic fluidics cartridge 201 of FIGS. 7, 8, and 9. However, the second exemplary fluidics cartridge 301 of FIGS. 10, 11, 12, 13, 14, and 15 may be modified to include the spring, provided a container lock retaining member is also provided.

Second, a receptor cover 281 (FIGS. 10 and 11) is affixed over an end of the sleeve 260 in which the receptor 269 is formed. The receptor cover 281 may be foil or other type of removable seal.

Third, the container 220 (FIGS. 12, 13, and 14) is inserted within the receptor 269 using a container holder. The container holder is held within the receptor 269 by a user, and/or by an attachment means (such as, but not limited to a friction fit, a snap fit, etc.), while the plunger 107 is pushed.

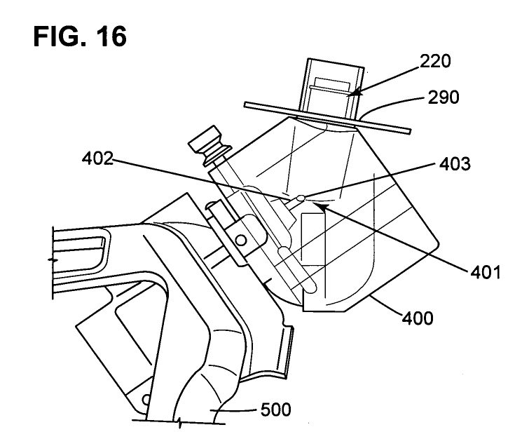

The container holder 290 can be formed of any suitable material. The container holder can be manufactured separately from the container 220. Alternatively, the container 220 may be integrally formed with the container holder. Container carriers 290 may be color-coded and/or patterned for different types of assays, and may optionally include a RFID tag 291 (FIGS. 12, 13, and 14). The container holder 290 has a size and shape that permits a gloved hand to easily insert a container 220 into the receptor 269. An assay opening 292 may be formed in a portion (e.g., bottom and/or sidewall) of the container holder 290. A laser from a portable substance identification device 500 (FIG. 16) can be directed through the assay opening 292 to impinge a pellet magnetically formed within an interior of the container 220.

FIG. 16 is a transparent side view of an embodiment of an interface cartridge 400 that is removably coupled with a portable substance identification device 500 and to which a container 220, in an optional container holder 290, is illustratively attached. The interface cartridge 400 acts as the interface between a reaction chamber (e.g., the container 220) and the portable substance identification device 500, which has a laser source, probe, Raman spectrometer, signal processor, and display. The interface cartridge 400 has a magnet 401, a path for the laser beam 402 to shine, through the assay opening 292 (FIGS. 12, 13, and 14), onto a pellet 403 formed within the container 220 (e.g., reaction chamber); and is designed to accept the container 220 and/or the container holder. The interface cartridge 400 may also be configured to removably quick-connect with the portable substance identification device 500. The pellet may be formed by the magnet of a plurality of tagged particles of a sample introduced into the fluidics cartridge by the collector. One or more of the particles may be magnetic.

To promote faster and more uniform pellet formation, the interface cartridge 400 may include a shield (not shown) about the magnet 401 that reduces stray magnetic fields and condenses and focuses the magnet's magnetic field about a pellet forming portion of the container 120. In one embodiment, a magnet holder also functions as the magnet shield. A portion of the magnet may be tapered. The magnet may be stationary or movable within the interface cartridge 400.

The interface cartridge 400 is also configured to perform an up to 3-axis adjustment to ensure that the laser beam 402 is properly aligned to strike the pellet 403 that is formed in the container 120.

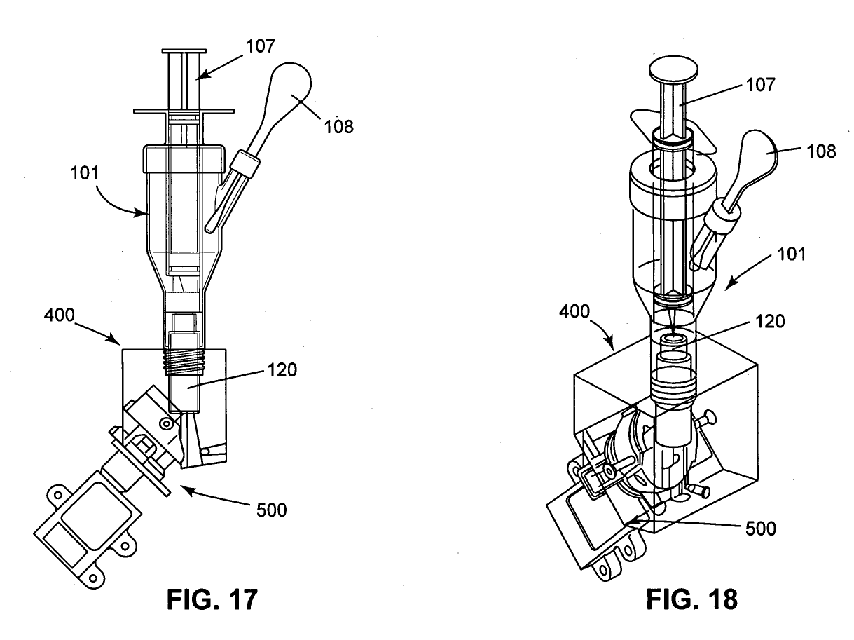

FIGS. 17 and 18 are transparent side views of an embodiment of an interface cartridge 400 coupled with a portable substance identification device 500 and further coupled with a fluidics cartridge 101 and a container 120, of the embodiment shown in FIGS. 1, 2, and 3. As previously mentioned, the fluidics cartridge 101 comprises a plunger 107 and a collection stem 108.

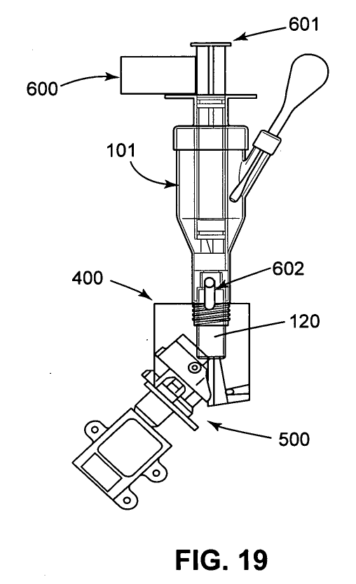

FIG. 19 is a transparent side view of an embodiment of an interface cartridge 400 coupled with a portable substance identification device 500 and further coupled with a fluidics cartridge 101 and a container 120, the fluidics cartridge 101 including an assay tab 600, a validation tab 601, and a validation capsule 602.

Features of a fluidics cartridge 101 that enable a validation step are shown in FIG. 19. In this case, a reagent that can be used as a simulant for a target analyte resides in a sealed validation capsule 602. For ease of reference only, and not by way of limitation, the reagent used as a simulant may be referred to as one of “a validation reagent” and “a liquid validation reagent.” The validation capsule is disposed within an inner chamber of the sleeve, to be pierced by a second, subsequent motion of the plunger.

The plunger 107 is equipped with two components—an assay tag 600, which must be removed before the plunger 107 can be pressed a first time; and a validation tab 601, which must be removed before the plunger 107 can be pressed a second (subsequent) time to pierce a validation capsule 602 that contains a liquid validation reagent.

Alternatively, the validation reagent can be added to the container 120 directly:

(a) either by using the fluidics cartridge 101 or a syringe 106 filled with a liquid validation reagent, or

(b) by using a container containing one or more solid or liquid validation reagents. Implementing stage (b) may include: piercing a container snap cap, emptying the one or more validation reagents into the container 120, and replacing (or covering) the original container snap cap with a new cover.

For validation of a negative assay result a reagent consisting of a target surrogate can be introduced in the buffer liquid of the fluidics cartridge 101 instead of the sample from the sample collector 108. The assay procedure is then performed with the container 120 into which the sample was first introduced (the agitation may not be necessary). A positive result with the surrogate indicates that the original reagents in the container 120 were functioning properly and validates the negative result.

For validation of a positive assay the magnetic particle pellet in the container 120 is dispersed by shaking the container 120 after removal from the interface cartridge 400. The container 120 is then introduced back into the interface cartridge 400; the magnetic pellet is reformed; and a laser-produced Raman signal is measured. If the result is still positive, the original positive result is validated.

FIGS. 20-24 are side views of an embodiment of a prototype container 320 and container holder 390, as well as a method for making the same. FIGS. 20(a) and 21(a) depict several off-the-shelf components. FIGS. 20(b) and 21(b) depict the same off-the-shelf components after modification and/or full or partial assembly. Referring to FIGS. 20(a) and 21(a), the off-the shelf components include a centrifuge conduit 900, a container holder cap 901, a container 320, a septum 902, and a container snap cap 903. In one embodiment the container snap cap 903 is formed of a material that can be pierced by an injection needle (or other type of conduit 113, 213 (FIGS. 1 and 8, respectively)). Alternatively, the container snap cap 903 may be hollow, e.g., may have a channel formed therein. The channel formed in the container snap cap 903 may be configured to permit passage of a needle tip through the container snap cap 903 and into the interior of the container 320. In one embodiment, the container holder cap 901 may be a centrifuge conduit screw cap. As further explained below, an opening 904 (e.g., orifice or hole) may be formed through a planar surface of the container holder cap 901. For ease of reference only, and not by way of limitation, the container holder cap 901 may be referred to herein as one of a “container holder screw cap” or a “container holder cap.” As described below, the centrifuge conduit 900 and the container holder cap 901 are each modified to form a container holder 290.

Referring to FIGS. 20(b) and 21(b), the container snap cap 903 may be inserted within the container 320. The container 320 may be inserted within the centrifuge conduit 900. The septum 902 may be inserted within the centrifuge conduit screw cap 901.

FIG. 22 depicts a capped container 320 inside a modified centrifuge conduit 900, with a septum 902 placed on top the capped container 320. A conical end of the centrifuge conduit 900 has been cut to form an assay opening 392. FIG. 23 is an end view of the prototype container holder 390 showing the assay opening 392 that provides access to the container 320 for pellet formation and spectroscopic analysis. Retention of the container 320 within the container holder 390 is accomplished in one embodiment by a container retaining member 906 formed proximate the assay opening 392. In one embodiment, the retaining member 906 is an annular ring, or shoulder, that surrounds and/or defines the assay opening 392. FIG. 24 is a side view of the fully assembled container holder assembly 390, and illustrates a different retaining member 905 attached to an exterior of the centrifuge conduit 900. The retaining member 905 may be configured to retain the container holder 390 within one of a fluidics cartridge 101 and an interface cartridge 400.

In an embodiment, the container holder 390 shown in FIGS. 20-24 is constructed by modifying a cylindrical screw cap 901 and by modifying a centrifuge conduit 900 having a conical closed end and an open end. The open end of the centrifuge conduit 900 may be configured to receive the container holder cap 901. As illustrated in FIGS. 20(b), 21(b), 22 and 23, a portion of the conical end of the centrifuge conduit 900 is trimmed to form the assay opening 392 and the container-retaining member 906 described above. To prevent a container 320 from slipping out of the container holder 390, a portion of the container-retaining member 906 is configured to engage a closed end (bottom) of the container 320 when the container 320 is inserted within the centrifuge conduit 900 (e.g., within the container holder 390). Referring to FIG. 21(b), an opening 904 may be formed in a central portion of the container holder cap 901. Referring to FIG. 21(b), a septum 902 is provided that fits on top of the capped container 320 and has a diameter sufficient to cover a capped end of the container 320, when the septum is positioned on top of the container snap cap 903. As noted below, the septum 902 may be held in place by the container holder cap 901.

In use, a container 320 is filled with lyophilized (e.g., freeze-dried) reagents or other types of reagents, and a container snap cap 903 is inserted into the open end of the container 320. The loaded and capped container 320 is then inserted, into the interior of the container holder 390 (e.g., centrifuge conduit 900), until the closed end (e.g., bottom end) of the container 320 engages an interior portion of the container-retaining member 906. A septum 902 is either placed on top of the container snap cap 1903 or is inserted into the modified container holder cap 901, which in either case is screwed tightly onto an end of the container holder 390 (e.g., centrifuge conduit 900). The container holder cap 901 holds the septum 902 firmly against the container snap cap 903. The septum 902 prevents a punctured container snap cap 903 from leaking during mixing (e.g., after the container snap cap 903 is pierced during the injection of a liquid sample). In one embodiment, the septum 902 is held in place by screwing the container holder cap 901 onto the container holder 390 (e.g., the centrifuge conduit 900). In other embodiments, other fastening mechanisms, such as press fitting, snap fitting, or adhering may be used to mate the container holder cap 901 with the container holder 390 and hold the septum 902 in place. When fully assembled, a portion of the container holder cap 903, which overlaps the exterior of the container holder 390, provides a retaining member (ridge or lip) 905 configured to hold the completed container holder 390 within the receptor 369 of a fluidics cartridge 101, 201, 301. Alternatively, the retaining member 905 may be attached to, or formed integrally with, the container holder 390.

Advantages associated with the embodiment of the container holder 390 shown in FIGS. 20-24 may include, but are not limited to one or more of the following:

(a) the container snap cap 903 seals the container 320 tightly to keep out humidity;

(b) the capped container holder 390 prevents the container 320 from breaking if dropped; and

(c) the container holder cap 901 that holds the re-sealable septum 902 tightly in place prevents sample leakage when a needle (e.g., conduit 113) is withdrawn after piercing (or passing through) the container snap cap 903, and prevents sample leakage during agitation or transport of the container 320.

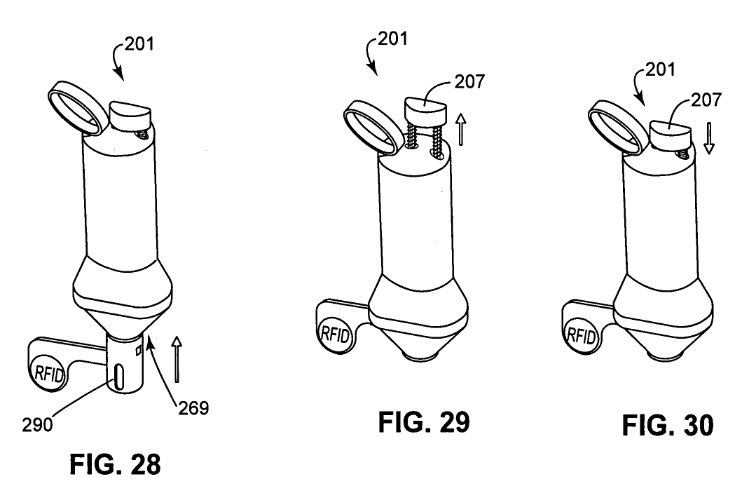

FIGS. 25-30 are side perspective views of the exemplary automatic fluidics cartridge 201 of FIGS. 7, 8, and 9, modified in accordance with the principles of the first embodiment of the fluidics cartridge 101 shown in FIGS. 1, 2, and 3, but with an ergonomic skin 920, a port cover 273, a receptor cover 281, and a container holder 290 that includes an RFID tag 292. FIG. 25 illustrates the exemplary automatic fluidics cartridge 201 in its initial state, with the plunger 107 pushed and with each of the port cover 273 and receptor cover 281 in place. In FIG. 26, the port cover 273 is removed, and a sample collector 108 is inserted through the port 104, as described above. In FIG. 27, the receptor cover 281 is removed, and a container holder 290, which optionally comprises an RFID tag 292, is positioned for engagement with the receptor 269. In FIG. 28, the container holder 290 is urged into engagement with the receptor 269, and a conduit 213 (not shown in FIG. 28) pierces the septum 902 (shown in FIG. 27) of the container 220. In FIG. 29, the plunger 107 is pulled to allow a sample-laden liquid medium to flow into an inner chamber of the fluidics cartridge 201 as a prelude to pushing (all or a portion of) this fluid into the container 220 with a subsequent pushing of the plunger 107. In FIG. 30, the plunger 207 is pushed to transfer a predetermined sample aliquot of sample-laden liquid medium into the container 220. Thereafter, the container holder 220 may be removed from the fluidics cartridge 201 and fitted to an interface cartridge 400 (FIGS. 16, 17, 18, and 19) for measurement by a laser-based Raman spectrometer, which forms part of a portable substance identification device 500 (FIGS. 16, 17, 18, and 19).

### Alternative Embodiments

Referring to FIGS. 1, 2, and 3, another fluidics cartridge embodiment can be made with a single chamber (e.g. a single conduit syringe). In this embodiment, the outer and inner chambers are combined and a plunger 107 is configured to push an entire column of the liquid medium into a container 120, 220, 320, instead of only an aliquot.

A modification to the plunger 107 of the syringe 106 to convert this into a collector 108 is also contemplated. In this embodiment, a rubber membrane at the end of the plunger stem is modified to hold a micro-applicator (or other type of collector tip 112). In this embodiment, the plunger 107 is kept separate from the syringe 106. The syringe 106 is used to store the liquid medium 105 with a removable seal at the top. The plunger 107 with micro-applicator attachment is used for sample collection and inserted into a plunger channel after removing a seal at the top of the plunger channel.

Another modification comprises a hole on a rubber membrane of the plunger 107. In this embodiment, insertion of the sample collector 108 through the rubber membrane seals the rubber membrane and introduces the sample into the liquid medium 105. The assay can then be conducted as described above.

In one embodiment, the fluidics cartridge 101, 201 is configured to be disposed of after use. Alternatively, the fluidics cartridge 101, 201 is configured to be reused after being decontaminated and being re-filled with liquid medium 105. In one embodiment, the fluidics cartridge 101, 201 includes a port through which a packet of liquid medium 105 is inserted. Once inside the fluidics cartridge 101, 201, the packet(s) of liquid medium 105 is pierced to refill the fluidics cartridge 101, 201 with liquid medium 105. Thereafter, the empty packet is removed from the fluidics cartridge 101, 201 and discarded.

In an embodiment, the interface cartridge 400 comprises a laser compartment and/or a magnet compartment, and is reusable.

The conduit 113,213 may be replaced with, or disposed within, a flexible conduit (or a pipette-tip), that is configured to deliver a predetermined sample aliquot of liquid medium 105 into a sealed container 120, 220, 320. With all of the above (conduit 113, 213) embodiments, the fluidics cartridge 101, 201 may have a pipette-like feature that enables attaching a container 120, 220, 320 introducing a sample-laden liquid medium 105 into the container 120, 220, 320, and afterwards detaching the container 120, 220, 320 which now contains the sample-laden liquid medium 105. This option of attaching and detaching the container 120, 220, 320 allows several assays with one sampling and one dilution, by repeated dispensing and thus reduces the cost per assay significantly.

The self-healing sealing member (e.g., septum) 902 described above may be replaced with a retractable cap.

The sample collector 108 may be stored dry or wet. If stored dry, the sample collector 108 may be separate from the fluidics cartridge 101, 201. If stored wet, the sample collector 108 may be pre-inserted within the fluidics cartridge 101, 201.

One or more venting holes may be formed in an appropriate portion of the fluidics cartridge 101. These venting holes may be formed in one or more materials that prevent fluid leakage, but allow for gas to escape or enter.

A check valve may be inserted between the inner chamber 103 and the conduit 113, 213 (e.g. needle) that will allow liquid to only flow out of the cartridge, but allows air to be drawn in. This enables plunger 107 to be retracted (e.g., pulled) for a possible subsequent liquid dispensation into another container 120, 220, 320. This check valve may be coupled to the cartridge and the needle by accepted means such as a Luer lock.

Embodiments of the substance identification apparatus described herein facilitate performing a field assay of a sample in about five minutes or less, which is significantly faster than the fifteen minutes plus required by prior substance identification devices.

Decontamination of any of the parts of the substance identification apparatus is accomplished using any known decontamination technique. Non-limiting examples of such techniques include, but are not limited to: autoclave sterilization and bleaching. In one embodiment, the fluidics cartridge 101, 201; the container 120, 220, 320; the container holder 290,390; and or the interface cartridge 400 are decontaminated via immersion in a bleach solution; or by being coated/sprayed with a bleach solution.

Embodiments of the claimed invention simplify the series of intricate laboratory steps normally used to perform a bioassay, and provide an ergonomic package that allows the assays to be performed in a laboratory or at an incident site, in any level of safety protective clothing.

Embodiments of the claimed invention are directed to providing, among other advantages and features, one or more of the following:

(1) simplicity of use, with minimal steps required of a user;

(2) a shape and size that are configured for easy operation by a user wearing protective clothing designed to protect against various types of hazardous substances;

(3) easy collection of a sample in various forms (liquid, powder, solid, etc.) for assay testing;

(4) dissolution or suspension of a collected sample in a liquid medium 105, a non-limiting example of which is a phosphate buffered saline solution;

(5) transfer of all or a predetermined fraction of the sample/liquid medium 105 into a reaction chamber, which may contain (or may be configured to contain) one or more target capture and tagging reagents, which capture and tagging reagents may include at least one type of SERS particle and at least one type of magnetic capture particle, both conjugated with appropriate binding agents (e.g., antibodies, and the like);

(6) optional acceleration of the tagging reaction via any suitable type of agitation, if needed;

(7) apparatus configured to collect and/or concentrate the reacted reagents into an agglomerate (e.g., a pellet) of SERS and magnetic particles at a predetermined location in the reaction chamber, which means for collecting/concentrating may, in one embodiment, include at least a magnetic field;

(8) apparatus and/or software for detecting and processing the SERS signal from the agglomerate by shining a laser on it to identify one or more substances of interest (if any) present in the collected sample;

(9) multiple dispenses of the liquid medium 105 in the first member to perform assays on additional samples;

(10) using the sample-laden liquid medium 105 to perform additional assays for other bioagents and/or for validation purposes; and

(11) a single device capable of identifying industrial and other chemicals as well as biological materials.

An embodiment of a substance identification system may include one or more of the following features, including any suitable combination thereof:

(A) A clean sample collector that is either wet or dry, which is used to collect a sample of a substance of interest. Possible embodiments of the sample collector include, but are not limited to, a MICROBRUSH® brand micro-applicator, manufactured by MICROBRUSH® International of Grafton, Wis., a sponge, a microfiber cloth, a swab, and the like.

(B) A first member (e.g., the fluidics cartridge 101, 201 described above) filled with the liquid medium 105 that receives the sample collector 108. Thereafter, the sample is then suspended or diluted in the medium, with mechanical shaking if required. Possible embodiments of one or more components that may be included in the first member include, but are not limited to, a syringe 106, a syringe 106 inside an outer conduit, a syringe 106 inside a syringe 106, etc.

(C) Apparatus configured to transfer the sample-laden liquid medium 105 to a second member (e.g., the reaction chamber described above) that contains the capture reagents and tagging reagents. Possible embodiments include (a) sharp syringe needle piercing a septum or foil-sealed cap 110 on a glass or plastic container 120 and (b) a blunt pipette dispensing into a container 120 that is capped with a removable foil cap. A predetermined partial portion of the liquid medium 105, or the whole amount of the liquid medium 105, can be transferred into the second member.

(D) Apparatus configured to remove the first member (fluidics cartridge 101, 201) from the second member (container 120, 220, 320). Such means may include, but are not limited to:
(1) a continuous or partial annular ridge formed about the exterior of the second member that mates with a locking member formed in the first member;
(2) a continuous or partial annular ring formed about the exterior of the second member that mates with an annular ring formed in the first member;
(3) a thread formed about the exterior of the second member that mates with a corresponding thread formed in the first member; and
(4) any other suitable type of mechanical fastener that removably couples the first and second members.

(E) Apparatus configured to agitate the second member (container 120, 220, 320)—by itself, while attached to the first member (fluidics cartridge 101, 201), and/or while attached to a container holder (290,390). Non-limiting examples of the means for agitating may include a hand, a rocker, or a rotator. The rocker and rotator may each be battery-powered or mechanical-spring powered.

(F) A third member (e.g., the interface cartridge described above) that mounts on a portable substance identification device and receives the container 120, 220, 320, or a portion of a fluidics cartridge/container holder that contains the container 120, 220, 320. A magnet coupled with the third member can be used to concentrate magnetizable particles in the solution to form a pellet. SERS tags can be attached to the magnetic particles through a target substance of interest, if the target substance of interest is present in the solution. The third member is configured to align a laser of the portable substance identification device (at the focal point of the laser and collection optics) with the pellet formed in the container 120, 220, 320 for target identification. The third member (and/or a container holder (290,390)) includes a material that blocks ambient visible and infrared radiation from reaching a pellet forming area of the container 120, 220, 320. Preventing ambient radiation from reaching the pellet forming area of the container 120, 220, 320 speeds processing times and reduces false alarms. A portion of the container 120, 220, 320 may be shielded to block ambient visible and infrared radiation from reaching a pellet forming area of the container 120, 220, 320.

(G) Apparatus configured to prevent accidental multiple transfers of reagent medium into a single container 120, 220, 320. In one embodiment, this is accomplished by requiring the container 120, 220, 320 to be removed from the fluidics cartridge 101 post-transfer before another transfer can be initiated.

(H) An optional RFID tag, which is used to identify the second member (container 120, 220, 320). In such an embodiment, the portable substance identification device has a RFID antenna and is configured to read or write information on the RFID tag that is attached to the container 120, 220, 320 (or that is attached to a container holder (290,390) used to carry the container 120, 220, 320 and/or to couple the container 120, 220, 320 with the fluidics cartridge 101, 201). This allows the portable substance identification device to read the particulars of each container 120, 220, 320 (e.g. target agents, date of manufacture etc.). In addition the portable substance identification device can optionally write to the RFID tag details such as date of test, results of tests etc. The RFID tag can also prevent accidental reuse of a used container 120, 220, 320. For example, when the portable substance identification device reads that container 120, 220, 320 has previously been used, a warning can be given to the user. Alternatively, the portable substance identification device can be automatically prevented from carrying out the assay sequence.

(I) A portable substance identification device configured to perform laser-based Raman spectroscopy of a sample in the container.

Additionally, in one embodiment, any sample-laden liquid medium 105 that remains after a first assay is performed can be used for additional tests to a) confirm the results of a prior assay, b) test for other substances of interest using additional reaction chambers, or c) to perform various validation tests to ensure proper operation of the instrument and assay.

As explained above, the conduit 113 has an interior channel that is configured to provide a flow path between the interior of the inner chamber 10 and an interior of a container 120. Thus, in any of the above embodiments, a first portion of the conduit 113 is coupled with, or integrally formed with, a wall of the inner chamber 10, and a second portion of the conduit 113, which may be either sharp or blunt, is disposed within the receptor 169. For example, where a container 120 having a self-sealing sealable member 122 is used, the second portion of the conduit 113 is sharp and tapers to a point. In an alternate embodiment, where the second portion of the conduit 113 is configured to dispense contents of the inner chamber 10 into an open end of a container 120, the second portion of the conduit 113 is blunt.

In addition to the various embodiments described above, the collector 108 may be configured to collect a substance of interest using a suction apparatus or a siphonage apparatus.

In one embodiment, a method comprises collecting a sample of a substance of interest on a portion of a sample collector. The method further comprises inserting the sample of the substance of interest into a chamber of a fluidics cartridge. The method further comprises dispensing the sample of the substance of interest together with a liquid medium into a container. The method may further comprise analyzing the dispensed sample of the substance of interest within the container and outputting a signal indicative of a result of the analysis. The result of the analysis may be an identification of the substance of interest or a likelihood of an identification of the substance of interest.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the scope of the following claims.

What is claimed is:

1. A fluidics cartridge, comprising:
an outer chamber having a port configured to receive a sample collector;
an inner chamber positioned within the outer chamber, wherein the inner chamber has one or more openings formed in a structure thereof; and
a conduit coupled with the inner chamber, the conduit having a first portion coupled with a portion of the outer chamber and a second portion.

2. The fluidics cartridge of claim 1, wherein the second portion of the conduit is sharp and tapers to a point.

3. The fluidics cartridge of claim 1, wherein the second portion of the conduit is blunt.

4. The fluidics cartridge of claim 1, further comprising:
a plunger configured to sealably engage and move within an interior of the inner chamber; and
a receptor formed at one end of the fluidics cartridge and configured to prevent the second portion of the conduit from contacting an object external to the fluidics cartridge.

5. The fluidics cartridge of claim 1, further comprising a container coupled with the conduit.

6. The fluidics cartridge of claim 1, wherein the outer chamber is configured to store a liquid medium.

7. The fluidics cartridge of claim 1, wherein the inner chamber is configured to store a liquid medium.

8. A fluidics cartridge, comprising:
an outer chamber having a port configured to receive a sample collector, wherein the outer chamber is configured to store a liquid medium;
a plunger extending through the outer chamber and coupled with a plunger handle; and
a conduit connected to the plunger and having a flow path, wherein the plunger is configured to transfer a portion of the liquid medium through the flow path of the hollow conduit when the plunger is pushed.

9. The fluidics cartridge of claim 8, further comprising:
a sleeve configured to prevent the conduit from contacting an object external to the fluidics cartridge.

10. The fluidics cartridge of claim 9, wherein the sleeve comprises a first detent, a second detent, and receptor configured to receive a container.

11. The fluidics cartridge of claim 10, further comprising:
a plunger rod coupled with the plunger handle and having a free end.

12. The fluidics cartridge of claim 11, further comprising:
a locking pawl formed at the free end of the plunger rod and configured to engage one of the first detent and the second detent.

13. The fluidics cartridge of claim 8, further comprising:
an inner chamber; and
a check valve positioned between the inner chamber and the conduit, wherein the check valve is configured to allow liquid to only flow out of the inner chamber and to allow air to be drawn into the inner chamber.

14. The fluidics cartridge of claim 8, further comprising:
an assay tag coupled with the plunger.

15. The fluidics cartridge of claim 8, further comprising:
a validation tag coupled with the plunger; and
a validation capsule containing a validation reagent,
wherein the validation tag must be removed before the plunger can be pressed to pierce the validation capsule.

16. A substance identification system, comprising:
a container;
a fluidics cartridge configured to receive the container and to transfer a sample of a substance of interest and a liquid medium to an interior of the container; and
an interface cartridge configured to position the container for analysis of the sample of the substance of interest.

17. The substance identification system of claim 16, further comprising:
a portable substance identification device configured to analyze the sample of the substance of interest.

18. The substance identification system of claim 16, wherein the container comprises a self-healing sealable member and is configured to store a predetermined amount of a reagent.

19. The substance identification system of claim 18, further comprising:
a RFID tag attached to the container.

20. The substance identification system of claim 16, wherein the interface cartridge includes a material that blocks ambient radiation from reaching an interior of the container.

21. The substance identification system of claim 16, wherein a portion of the container is shielded to block ambient radiation from reaching an interior of the container.

22. The substance identification system of claim 16, further comprising:
a container holder, wherein the container holder includes a material that blocks ambient radiation from reaching an interior of the container.

23. The substance identification system of claim 22, wherein the container holder further comprises:
an assay opening formed in a portion of the container holder.

24. The substance identification system of claim 23, wherein the interface cartridge further comprises:
a magnet; and
a path for a laser beam to shine, through the assay opening onto a pellet formed within the container by the magnet.

25. The substance identification system of claim 24, wherein the interface cartridge further comprises:
a shield about the magnet that is configured to reduce stray magnetic fields and configured to condense and focus the magnet's magnetic field about a pellet forming portion of the container.

26. A method, comprising:
collecting a sample of a substance of interest on a portion of a sample collector;
inserting the sample of the substance of interest into a chamber of a fluidics cartridge; and
dispensing the sample of the substance of interest together with a liquid medium into a container.

27. The method of claim 27, further comprising:
analyzing the dispensed sample of the substance of interest within the container; and
outputting a signal indicative of a result of the analysis.
